(19) United States
(12) Patent Application Publication
(10) Pub. No.: US 2015/0288246 A1
(43) Pub. Date: Oct. 8, 2015

(54) Motor Rotor Dynamic Balance Compensation Set

(71) Applicant: TRICORE CORPORATION, Changhua County (TW)

(72) Inventor: Ting-Yi KOO, Changhua County (TW)

(21) Appl. No.: 14/328,202

(22) Filed: Jul. 10, 2014

(30) Foreign Application Priority Data
Apr. 7, 2014 (TW) 103205947

(51) Int. Cl. H02K 7/04; F16F 15/28

(52) U.S. Cl. CPC H02K 7/04; F16F 15/28

(57) ABSTRACT

A motor rotor dynamic balance compensation set includes a mounting member including a center through hole for mounting on the shaft of a motor rotor and a plurality of grooves equiangularly spaced around the outer perimeter thereof, and one or multiple counterweights selectively mountable in the grooves of the mounting member. After performed a dynamic balancing calibration on the motor rotor to discover the position and weight needed for dynamic balance compensation, the engineer can quickly find out the groove on the mounting member corresponding to the compensating position, and then insert a mating counterweight into the groove to complete Thus, the whole calibration process is relatively simple and weight compensation can be directly performed, enhancing the accuracy of the compensation.

### BACKGROUND OF THE INVENTION

1. Field of the Invention

The present invention relates to motor rotor dynamic balancing technology and more particularly, to a motor rotor dynamic balance compensation set, which facilitates accurate weight compensation for the dynamic balance of a motor rotor.

2. Description of the Related Art

Motor rotor dynamic balancing calibration is an important procedure before the delivery of a motor or during its maintenance work. This procedure is adapted to detect the amount of unbalance (e.g., centrifugal force) of the motor rotor during rotation. The engineer can correct the unbalance by means of weight compensation, avoiding generation of the unnecessary vibration and noise to shorten the lifespan of the motor rotor due to dynamic unbalance.

Conventionally, there are two compensation measures to achieve motor rotor dynamic balancing compensation. One compensation measure is to directly attach clay to the opposing front and back sides of the motor rotor corresponding to the dynamic unbalancing position. This compensation method is relatively simple. However, the attached clay can easily fall from the motor rotor during a high speed rotation.

The other compensation measure is to attach a counterweight to the opposing front and back sides of the motor rotor and then to cut the attached counterweight in the reversed direction corresponding to the dynamic unbalancing position with a metal milling machine, enabling the motor rotor to reach dynamic balance. However, it is not easy to accurately control the cutting amount when cutting the counterweight with a metal milling machine, and likely to make errors.

### SUMMARY OF THE INVENTION

The present invention has been accomplished under the circumstances in view. It is the main object of the present invention to provide a motor rotor dynamic balance compensation sett, which facilitates accurate weight compensation for the dynamic balance of a motor rotor.

To achieve this and other objects of the present invention, a motor rotor dynamic balance compensation set of the present invention comprises a mounting member having an annular configuration, and a counterweight. The mounting member comprises a center through hole for mounting on the shaft of a motor rotor, and a plurality of grooves equiangularly spaced around the outer perimeter thereof. The counterweight is selectively mountable in the grooves of the mounting member.

Thus, after performed a dynamic balancing calibration on the motor rotor to discover the position and weight needed for dynamic balance compensation, the engineer can quickly find out the groove on the mounting member corresponding to the compensating position, and then insert a mating counterweight into the groove to complete Thus, the whole calibration process is relatively simple and weight compensation can be directly performed, enhancing the accuracy of the compensation.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a mounting member for motor rotor dynamic balance compensation set in accordance with the present invention.

FIG. 2 is a front view of the mounting member shown in FIG. 1.

FIG. 3 is an applied view of the present invention, illustrating the motor rotor dynamic balance compensation set installed in a motor rotor.

### DETAILED DESCRIPTION OF THE INVENTION

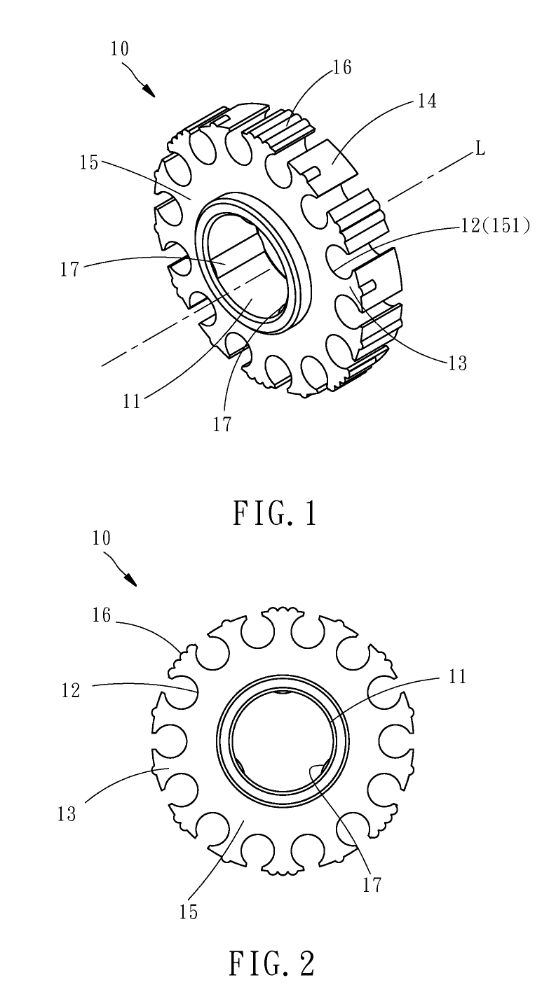

Referring to FIGS. 1 through 3, a motor rotor dynamic balance compensation set 1 in accordance with the present invention is shown. The motor rotor dynamic balance compensation set 1 comprises two mounting members 10 mounted at two opposite sides of a motor rotor A, and at least one counterweight 20. The structural features of these components and their relative relationship are outlined hereinafter.

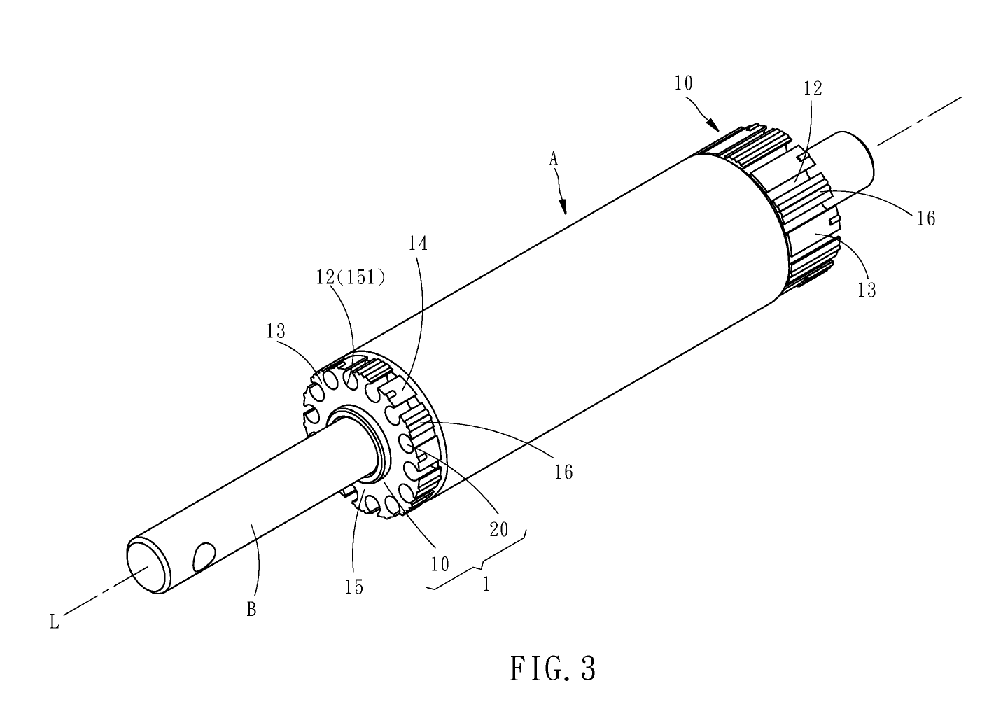

Referring first to FIGS. 1 and 2, the mounting members 10 have an annular configuration, each comprising a center through hole 11, three ribs 17 equiangularly spaced around an inner perimeter thereof within the center through hole 11 for enabling the mounting members 10 to be coaxially mounted on the shaft B of the motor rotor A (see FIG. 3), a plurality of grooves 12 of circular cross section (the amount of the grooves in this embodiment is 14) equiangularly spaced around an outer perimeter 14 thereof and extending through two opposing sidewalls 15 thereof in a parallel manner relative to the center through hole 11 and defining an opening 151 in each sidewall 15, a plurality of peripheral portions 13 respectively defined between each two adjacent grooves 12, and a graduation block 16 located in the middle of an outer surface of each peripheral portion 13 for use as a mark to indicate the angular position. It is to be noted that the ribs 17, the grooves 12 and the peripheral portions 13 are respectively equiangularly spaced around the central axis L of the center through hole 11, thus, the total mass of each mounting member 10 is uniformly distributed to have the center of gravity of the respective mounting member 10 be located on the central axis L of the center through hole 11.

The quantity of the at least one counterweight 20 can be multiple. These counterweights 20 are rod shaped to fit the configuration of the grooves 12. further, the counterweights 20 are made in different weights. Each counterweight 20 can be selectively inserted through one opening 151 and press-fitted into the respective groove 12.

The invention uses a dynamic balancing measurement system to perform a dynamic balancing calibration test, measuring the position and weight needed for dynamic balance compensation. Because the principle and operation of this kind of dynamic balancing measurement system is of the known art and not within the scope of the spirit of the present invention, no further detailed description in this regard will be necessary.

After performed a dynamic balancing calibration on the motor rotor A through the dynamic balancing measurement system, the dynamic balancing equipment will indicate a compensating position that needs to be added with a compensation weight. Through the graduation blocks 16, the engineer can quickly find out the groove 12 of each mounting member 10 that corresponds to the indicated compensating position, and then insert in the groove 12 a mating counterweight 20 that is equal to the compensation weight. Thus, the calibration of the dynamic balance of the motor rotor A is done. If the compensating position corresponds to one peripheral portion 13, the engineering can rotate the mounting members 10 in fine scale to correspond the balancing position to one groove 12. Thus, the whole calibration process is relatively simple and weight compensation can be directly performed, enhancing the accuracy of the compensation.

It is to be noted that the grooves 12 are disposed in communication with the atmosphere in a direction perpendicular to the central axis L, thus the peripheral area of each mounting member 10 around the junction between each groove 12 and the atmosphere is relatively weakened; therefore, the inner wall of each groove 12 near this peripheral area is flexible and conducive to securing the inserted counterweight 20, preventing the inserted counterweight 20 from falling out of the respective mounting member 10. In order to enhance the connection tightness between the mounting members 10 and the shaft B, a person skilled in the art can apply an adhesive to bond the mounting members 10 to the shaft B after dynamic calibration. Further, because the grooves 12 are disposed far from the center through hole 11, each loaded counterweight 20 has a large radius of gyration relative to the central axis L of the center through hole 11. When compared to the conventional weight compensation technique, the invention can use a relatively smaller compensation weight to achieve the same torque effect.

It is worth of mentioning that the graduation mark design of the graduation block 16 on each peripheral portion 13 is not a limitation; a graduation groove or printing graduation index can be formed on each peripheral portion 13 to substitute for the graduation block 16. Further, the structural design of the grooves 12 to extend through the two opposite sidewalls 15 in a parallel manner relative to the center through hole 11 is also not a limitation. Further, any ordinary person skilled in the art can use elastic counterweights 20 for elastically deformably inserted into the grooves 12 to achieve the same effects.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A motor rotor dynamic balance compensation set, comprising:
at least one mounting member in an annular shape, each said mounting member comprising a center through hole for mounting on a shaft of a rotor, and a plurality of grooves located in an outer perimeter thereof; and
at least one counterweight for selectively mounted in said grooves of said at least one mounting member.

2. The motor rotor dynamic balance compensation set as claimed in claim 1, wherein said grooves are equiangularly spaced around the outer periphery of each said mounting member.

3. The motor rotor dynamic balance compensation set as claimed in claim 1, wherein said grooves extend through two opposite sidewalls of each said mounting member in a parallel relationship relative to the center through hole of the respective said mounting member.

4. The motor rotor dynamic balance compensation set as claimed in claim 1, wherein each said mounting member further comprises a plurality of peripheral portions respectively defined between each two adjacent said grooves, and a graduation mark located on each said peripheral portion.

5. The motor rotor dynamic balance compensation set as claimed in claim 1, wherein each said mounting member further comprises a plurality of ribs spaced around an inner perimeter thereof within said center through hole.

6. The mot rotor dynamic balance compensation set as claimed in claim 1, wherein the amount of said at least one mounting member is 2, and these two mounting members are adapted for mounting on a shaft of a rotor at two opposite sides.

7. A motor rotor dynamic balance compensation comprising.
at least one mounting member in an annular shape, each said mounting member comprising a center through hole for mounting on a shaft of a rotor, a plurality of grooves located in an outer perimeter thereof and extending through two opposite sidewalls thereof, and a plurality of ribs spaced around an inner perimeter thereof within said center through hole; and
at least one counterweight for selectively mounted in said grooves of said at least one mounting member.

8. The mot rotor dynamic balance compensation set as claimed in claim 7, wherein said grooves are equiangularly spaced around the outer periphery of each said mounting member; said ribs are equiangularly spaced around the inner perimeter of each said mounting member.

9. The motor rotor dynamic balance compensation set as claimed in claim 7, wherein each said mounting member further comprises a plurality of peripheral portions respectively defined between each two adjacent said grooves, and a graduation mark located on each said peripheral portion.
